(19) United States
(12) Patent Application Publication
(10) Pub. No.: US 2014/0274654 A1
(43) Pub. Date: Sep. 18, 2014

(54) Constitution of Environment-Friendly Glass for TFT-LCD

(71) Applicant: FORTUNE TECHNOLOGY CORP., New Taipei (TW)

(72) Inventor: Allen Yu, New Taipei (TW)

(21) Appl. No.: 13/845,306

(22) Filed: Mar. 18, 2013

(51) Int. Cl. C03C 4/20; C03C 3/091

(52) U.S. Cl. CPC C03C 4/20; C03C 3/091
USPC 501/66

(57) ABSTRACT

A constitution of environment-friendly glass for TFT-LCD is provided, which is employed in Thin Film Transistor Liquid Crystal Display, the constituents consist, expressed in terms of weight % on the oxide basis, of from 59 to 63 wt. % of SiO₂; from 13 to 17 wt. % of Al₂O₃; from 7 to 14 wt. % of B₂O₃; from 0.1 to 3 wt. % of BaO; from 0.5 to 3.5 wt. % of MgO; from 7 to 11 wt. % of CaO; from 0.2 to 6 wt. % of SrO; and from 0.05 to 0.4 wt. % of SnO₂. The constitution then can be melted to form environment-friendly glass for TFT-LCD with high stiffness. The environment-friendly glass for TFT-LCD is formed to allow increase in chemical resistance, so as to solve the conventional problems of insufficiency in both strength and hardness and of inclusion of environment-unfriendly constituents as As₂O₃ or Sb₂O₃.

### BACKGROUND OF INVENTION

1. Field of the Invention

The present invention relates to a constitution of environment-friendly glass for Thin Film Transistor Liquid Crystal Display, TFT-LCD, more particularly to a constitution capable of strengthening the structure of glass, raising its chemical resistance and devitrification resistance, without inclusion of environment-unfriendly constituents such as PbO, As₂O₃ or Sb₂O₃, and favorable for recycling.

2. Brief Description of the Prior Art

Nowadays, most of the display used in mobile facilities such as mobile phone, tablet is TFT-LCD that can significantly improve image quality. Basically, a piece of TFT-LCD panel needs two flat glass substrates used respectively for IC making and color filter usage. As heat resistance is required in the manufacturing process of TFT and alkali ingredients have negatively affect the properties of TFT, the flat glass substrate for TFT-LCD ordinarily employs alkali free aluminoborosilicate glass without the inclusion of alkali constituents (alkali group such as lithium, sodium, potassium). Usually, the elements in the alkali group are preferably used to help melting. If no flux is present, melting temperature and viscosity will be increased, whereby melting, clarifying, homogenizing and forming of glass will become difficult.

Flat glass substrate for TFT-LCD can be made by means of float technology, slot downdraw technology, and fusion overflow downdraw technology. Among these technologies, the fusion overflow downdraw technology is a non-contact forming process and the flat glass sheet made thereby has very smooth surface, no further polish required, which is adaptable to be employed as flat glass substrate for TFT-LCD.

Generally speaking, when making flat glass sheet by downdraw process, firstly the molten glass with high temperature and flowability passes through glass melting furnace, refining platinum system, and cooling tube in this sequence, and then flows to a distributor or trough having the function of distributing evenly the flow rate of molten glass. Thereafter, molten glass is pull down by pulling device and is cooled gradually so as to form flat glass sheet. In the manufacturing process, when molten glass flows through melting furnace and refining tube, molten glass has high temperature and flowability. When flowing through the cooling pipes, the temperature of the molten glass is reduced, so that the temperature can be further reduced to a temperature required for forming to keep its viscosity in constant range, when it flow through the distributor or trough having the function of distributing evenly the flow rate of molten glass.

Generally speaking, when the temperature of molten glass is reduced, the glass tends to generate crystallization phenomena which may causes devitrification (i.e., lose transparency due to crystal precipitation of glass), which leads to impurities generation on the surface or in the interior of the glass. This will result in the change of stress distribution inside glass, reduction of glass hardness and strength, deterioration of production yield rate.

When flat glass sheets are made by downdraw process, the forming temperature is controlled between 1085˜1250° C. In order to reduce the defect of devitrification and crystallization occurred on the surface or in the interior of glass, the method of reducing the liquidus temperature of molten glass is preferably employed. By adjusting glass constituents, and then the liquidus temperature of glass constituents can be reduced to a temperature lower than the lower limit temperature 1085° C. for forming. However, once the glass constituents are changed, in addition to the change of liquidus temperature of glass, the other important physical properties such as coefficient of thermal expansion, strain point and density are also subject to change, even some properties degrade to such a manner as to obstruct the normal usage of glass products. Therefore, how to adjust glass constituents such that the other important physical properties are not subject to excessive degradation when the liquidus temperature of glass is reduced is the key point.

With respect to the glass for LCD production, especially the glass for TFT-LCD production, the requirement on its physical properties is particularly stringent. Therefore, important properties such as coefficient of thermal expansion, strain point and density must be included in the important factors of assessment consideration.

Recently, a lot of new technologies with respect to the constitution of glass substrate have been developed by relevant designers and manufactures of glass substrate for TFT-LCD. For example, U.S. Pat. Nos. 5,811,361, 5,8519,395, and 6,060,168 have disclosed a glass substrate made from a glass constitution, in which the liquidus temperature of glass is still on the high side of 1090° C. above. Thus, when the glass is formed by downdraw process, various defects mentioned above take place to trigger crystallization phenomena in the glass that may cause problems of decrease in strength and of worse yield rate in final products.

What is more, conventional glass constituents often contain PbO, As₂O₃ and Sb₂O₃ that are harmful to human body and environment. For example, the glasses as disclosed in Taiwanese Patent Gazette No. I365861 and I319384 contain large amount of PbO that fails to meet requirement of environment standard. Further, the glass disclosed in a Taiwanese Patent Gazette No. 1252844 contains As₂O₃ and Sb₂O₃, served as refining agent in manufacturing process, are harmful to human body. However, if As₂O₃ and Sb₂O₃ are substituted by different constituents, original optical and physical properties of glass will be subject to change. Therefore, extensive research and development should be conducted on the ingredients and their weight percent of glass compositions so as to solve the problem.

In view of the above disadvantages occurred in conventional glasses, the present invention proposes a novel environment-friendly constitution for TFT-LCD in which environmentally unfriendly constituents such as PbO, As₂O₃ and Sb₂O₃ are substituted by adding or changing the proportion of constituents, so as to solve the problems of insufficiency in strength and hardness, inconsistency with environmental standard which causes the recycling of glass to be impossible.

### SUMMARY OF THE INVENTION

In view of the above demand, the main object of the present invention is to substitute environmentally unfriendly constituents such as PbO, As₂O₃ or Sb₂O₃ by adding or changing proportion of constituents, and then an environment-friendly glass for TFT-LCD having strengthened structure and devitrification resistance can be produced.

In order to achieve the above objects, the present invention is to strengthen the structure of environment-friendly glass for TFT-LCD by adding or changing proportion of constituents in glass constitution. The constituents of glass consist in terms of weight % on the oxide basis, of from 59 to 63 wt. % of SiO₂; from 13 to 17 wt. % of Al₂O₃; from 7 to 14 wt. % of B₂O₃; from 0.1 to 3 wt. % of BaO; from 0.5 to 3.5 wt. % of MgO; from 7 to 11 wt. % of CaO; from 0.2 to 6 wt. % of SrO; and from 0.05 to 0.4 wt. % of SnO₂; wherein the total contents of CaO, BaO, MgO and SrO is preferably 7.8%˜23.5%. The above constitution then can be melted to form stiff glass, and network structure can be formed in the glass by adding SiO₂; stiff surface of glass can be created, heat tolerance, devitrification resistance of glass can be increase, and rate of expansion of glass can be reduced by adding Al₂O₃; viscosity and coefficient of expansion of glass can be reduced by adding B₂O₃, MgO and CaO; and chemical resistance and devitrification resistance of glass can be raised by adding BaO and SrO so as to solve the problem of insufficiency in strength and hardness; and PbO, As₂O₃ or Sb₂O₃ can be substituted by SnO₂ which acts as a clarifier or antifoaming agent, so that the problems of conventional TFT-LCD glass, such as inconsistency with environmental standard that causes the recycling to be impossible.

### DETAILED DESCRIPTION OF PREFERRED EMBODIMENTS

The present invention is mainly to provide a constitution of environment-friendly glass for TFT-LCD, the materials of which consist in terms of weight % on the oxide basis of:
(1) SiO₂, 59%˜63.0%;
(2) Al₂O₃, 13.0%˜17.0%;
(3) B₂O₃, 7%˜14%;
(4) BaO, 0.1%˜3%;
(5) MgO, 0.5%˜3.5%;
(6) CaO, 7%˜11%;
(7) SrO, 0.2%˜6%;
(8) SnO₂, 0.05%˜0.4%
(9) wherein the total contents of CaO, BaO, MgO and SrO is preferably 7.8%˜23.5%.

According to the present invention, as the weight percent of each constituent according to its physical properties will place impact of different degree on the characteristic, structure and production of environment-friendly TFT-LCD glass, it is necessary to place limitation on the weight percent of each constituent, among which, SiO₂, Al₂O₃, and B₂O₃ share major parts of the weight percents and play important roles on the characteristic, structure and production of glass substrate. Therefore, the three constituents are the major ingredients, in which SiO₂ is for forming glass network structure, the preferred content of SiO₂ in weight % is 59%˜63%. If SiO₂ content is less than 59%, the glass produced is easily to get devitrification. On the other hand, if SiO₂ content is more than 63%, the melting temperature of glass is too high so that the glass produced is also easily to get devitrification. Al₂O₃ is used to increase the structural strength of glass so as to allow the glass to have a stiff surface, and then to increase both the heat and the devitrification resistance of glass, to reduce the rate of expansion of glass. The preferred content of Al₂O₃ in weight % is 13%˜17%. If Al₂O₃ content is less than 13%, the glass thus produced may be easily to get devitrification and is easily subject to corrosion by ambient moisture or chemical reagent. On the other hand, if Al₂O₃ content is more than 17%, the melting temperature of glass is too high to be advantageous for manufacturing in ordinary melting furnace. B₂O₃ is served to help melting in glass manufacturing for decreasing the viscosity of glass during glass melting. The preferred content of B₂O₃ in weight % is 7.0%˜14%. If B₂O₃ content is less than 7%, the role to help melting cannot be in full play. On the other hand, if B₂O₃ content is more than 14%, strain point of glass is significantly reduced so that this is disadvantageous to the application in subsequent processes.

According to the present invention, the other constituents such as CaO, BaO, MgO and SrO, other than the three major constituents SiO₂, Al₂O₃, and B₂O₃, only share the minor part of total weight percent, but they play important roles in affecting the viscosity and melting degree of molten glass. CaO is to facilitate the melting of glass, the preferred content of CaO is 7%˜11%. If CaO content is less than 7%, it is impossible to effectively lower the viscosity of glass. If CaO content is more than 11%, devitrification resistance of glass will become worse and coefficient of expansion will be remarkably increased, so it is disadvantageous for the application in subsequent processes. The preferred content of BaO in weight % is 0.1%˜3%. If BaO content is less than 0.1%, the glass produced is easily to get devitrification. If BaO content is more than 3%, the density of glass is too high and the strain point is significantly lowered. The function of SrO is similar to that of BaO, and the preferred content of SrO is 0.2%˜6%. If SrO content is less than 0.2%, the glass produced is easily to get devitrification. If SrO content is more than 6%, the density of glass is too high to be adaptable to the application of products. MgO is for lowering the viscosity and coefficient of expansion of glass so as to reduce contents of bubble and impurities. The preferred content of MgO in weight percent is 0.5%˜3.5%. If MgO content is more than 3.5%, the glass thus produced is easily to get devitrification. SnO₂ is an excellent refining agent and if SnO₂ is employed to serve as auxiliary boosting in melting furnace, SnO₂ will be fused into the molten glass accompanying with the gradual consumption of auxiliary boosting. Moreover, SnO₂ can also be obtained from prescription raw materials. But SnO₂ is easily to be condensed at low temperature place at platinum system and will drop into glass to form defect which may cause the production yield rate to be worsened. Excessive SnO₂ will place negative effect on the transmittance of glass, and this is disadvantageous to the application for liquid crystal display glass. Therefore, SnO₂ content shall not exceed 0.4%.

The abovementioned CaO, BaO, MgO and SrO, are to facilitate the melting degree of glass and to adjust the coefficient of thermal expansion of glass, however the total contents of CaO, BaO, MgO and SrO is preferably to be 7.8%˜23.5%. If the total contents of CaO, BaO, MgO and SrO is less than 7.8%, the melting temperature of glass becomes too high. On the other hand, if the total contents of CaO, BaO, MgO and SrO is more than 23.5%, not only the glass produced is easily to get devitrification but also the coefficient of thermal expansion of glass becomes too high.

In the implementation of the present invention, firstly the above constituents are well blended and the mixture thus formed is poured into a glass melting pot. After the mixture is melted into glass liquid, the temperature is reduced to the range required for forming, i.e., the temperature range is maintained in such a manner that the viscosity range is kept within 10^{4.6}˜10^{4.8} poise. Then, the glass sheet with predetermined thickness is formed by downdraw method. After the glass substrate is gradually cooled, it can be cut to form glass substrates for TFT-LCD usage.

Next, each of the abovementioned constituents according to the present invention is blended in different wt. % with the others and then a variety of glass samples are formed according to the above processes. Taking these samples as examples, the difference between the properties of coefficient of thermal expansion, strain point, density and liquidus temperature of glass can be apparently understood from the table.

Table 1 (example 1) is an embodiment of the present invention, the sample of which is made as follow: each of the compositions is normally used material and the wt. % thereof is according to corresponding value. After mixing homogeneously, the mixture is melted and uniformly stirred in a platinum heating system operating at a temperature of 1680° C., and then the glass liquid in melting state is formed by downdraw method and is cooled to form glass sheet. Next, measurements are conducted on the glass sample and the properties of coefficient of thermal expansion, strain point, density and liquidus temperature of glass sheet can be obtained respectively.

The measurements of each property value of each glass sample are conducted according to the methods below.
(1) coefficient of thermal expansion (unit: 10⁻⁷/° C.): A push-rod type thermal dilatometry is used to heat the glass and to measure the elongation of glass sample, from room temperature until a temperature (normally 0˜300° C.) at which the glass is no more elongated or even become softened to contract.
(2) Strain point (unit: ° C.): Heat the glass and measure to obtain the viscosity of glass sample versus temperature, and a temperature corresponding to a specific viscosity (10^{14.5} Poise) is used as the strain point.
(3) Density (g/cm³): A block of glass with 2 gram weight and without bubbles contained therein is utilized. The density is measured by the state how the glass sample is drifting in a density liquid.
(4) Liquidus temperature of glass (unit: ° C.): A glass chip smaller than 850 μm is placed in a vessel, then the vessel with the glass ship is put into a gradient furnace for a period of 24 hrs. Then, a microscope is used to observe the crystallization of the glass so as to determine the liquidus temperature of the glass.

TABLE 1

| | Example 1 |
|---|---|
| Weight % of SiO₂ | 59-63% |
| Weight % of Al₂O₃ | 13-17% |
| Weight % of B₂O₃ | 7-14% |
| Weight % of BaO | 0.1-3% |
| Weight % of MgO | 0.5-3.5% |
| Weight % of CaO | 7%-11% |
| Weight % of SrO | 0.2%-6% |
| Weight % of SnO₂ | 0.05%-0.4% |
| Weight % of MgO + CaO + SrO + BaO | 7.8%-23.5% |
| coefficient of thermal expansion (unit: 10⁻⁷/° C.) | 33 |
| Strain point (unit: ° C.) | 660 |
| Density (g/cm³) | 2.39 |

It is apparent from the data listed in table 1, the environment-friendly glass for TFT-LCD made by the constitution according to the present invention has coefficient of thermal expansion lower than 33*10⁻⁷/° C., strain point higher than 660° C., density smaller than 2.39 g/cm³ that are quite similar to the properties of ordinary high strength LCD glass substrate. Therefore, the glass sheet made by the constitution according to the present invention is adaptable to the glass substrate of ordinary liquid crystal display.

Summing up above, according to the present invention, network structure is formed in the glass by adding SiO₂; stiff surface of glass can be created, and then heat resistance, devitrification resistance of glass can be increased by adding Al₂O₃; viscosity and coefficient of thermal expansion of glass can be reduced by adding B₂O₃, MgO and CaO; chemical resistance and devitrification resistance of glass can be enhanced by adding BaO and SrO. In this way, the structure can be strengthened by adding and changing the proportion of constituents. It is found in the implementation, an environment-friendly glass for TFT-LCD with chemical resistance and devitrification resistance can be provided undoubtedly.

While the present invention has been described by preferred embodiments in conjunction with accompanying drawings, it should be understood that the embodiments and the drawings are merely for descriptive and illustrative purpose, not intended for restriction of the scope of the present invention. Equivalent variations and modifications conducted by person skilled in the art without departing from the spirit and scope of the present invention should be considered to be still within the scope of the present invention.

1. A constitution of environment-friendly glass for TFT-LCD, the compositions consist, indicated in terms of weight % on the oxide basis, of:
SiO₂, 59%˜63%;
Al₂O₃, 13%˜17%;
B₂O₃, 7%˜14%;
BaO, 0.1%˜3%
MgO, 0.5%˜3.5%;
CaO, 7%˜11%;
SrO, 0.2%˜6%; and
SnO₂, 0.05%˜0.4%.

2. The constitution of environment-friendly glass for TFT-LCD as claimed in claim 1, wherein the total contents of CaO, BaO, MgO and SrO in weight percent is 7.8%˜23.5%.
